(19) United States
(12) Patent Application Publication
(10) Pub. No.: US 2012/0140529 A1
(43) Pub. Date: Jun. 7, 2012

(54) Energy Recirculation and Active Clamping to Improve Efficiency of Flyback or Push Pull DC to DC Converters

(76) Inventors: Norman Luwei Jin, Rochester Hills, MI (US); Yimeng Jin, Rochester Hills, MI (US)

(21) Appl. No.: 12/958,404

(22) Filed: Dec. 2, 2010

(51) Int. Cl. H02M 3/335; H02M 3/337

(52) U.S. Cl. 363/21.12; 363/24; 363/16

(57) ABSTRACT

The present invention is a new circuit topology to improve the efficiency of a flyback or push-pull converter or any other DC/DC converter that incorporates a transformer and whose switching device's active node (drain for MOSFETs and collector for IGBTs) has no direct energy releasing path to the power supply. The present invention uses an auxiliary DC/DC converter separate from the main DC/DC converter to reroute the parasitic energy stored in the transformer's or inductor's leakage inductance, allowing for the output of the main DC/DC converter to be augmented with the energy that would otherwise be lost. The energy stored in the leakage inductance is converted and redirected to either the load side or the power supply side of the main DC/DC converter in a series or a parallel configuration. The present invention significantly increases the overall efficiency of the system by eliminating the power loss.

### BACKGROUND ART

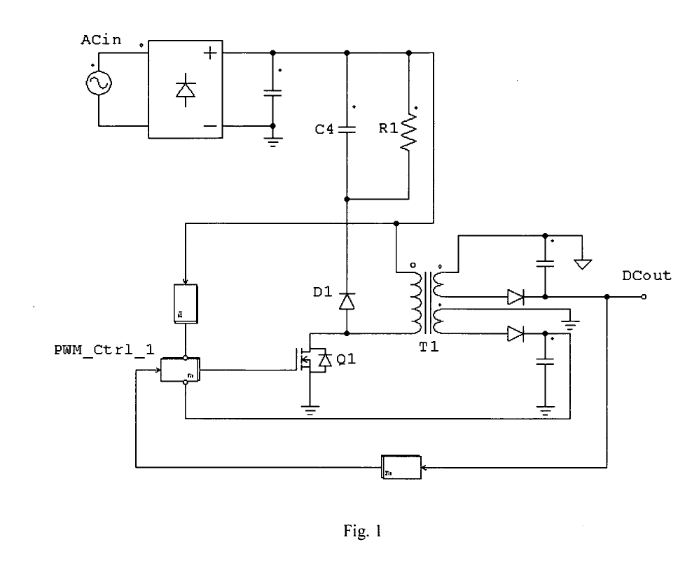

The vast majority of switching power supplies in today's market are flyback type DC/DC converters due to their simplicity and low cost (FIG. 1). In a flyback converter, the energy is stored in a magnetic core through the primary coil of T1, when power driver (Q1) is on (PWM_Ctrl_1 is the main DC/DC converter power switching device PWM gate control signal). The stored energy is released to the secondary coil of T1 when the power driver is turned off. In an actual transformer, there always exists a leakage inductance that can also store some energy when the power driver is on. That energy stored in the leakage inductance cannot be released to the secondary coil, because there is no magnetic link from the leakage inductance to the secondary coil.

When the power driver is turned off, the energy stored in the leakage inductance has no available route and generates high voltage spikes over the drain or collector of the power driver device. These voltage spikes introduce extra switching loss on the power driver and also cause breakdown of said power driver device if the spike is sufficiently high.

To combat this portion of parasitic energy, usually a voltage clamping circuit is added from the drain or collector of the power device to the DC power supply line (see D1, C4, and R1 in FIG. 1). The clamping circuit is often composed of a fast recovery diode D1, a capacitor C4, and a resistor R1. With the help of this voltage clamping circuit, the energy stored in the leakage inductance will be transferred to a capacitor C4 through the diode D1 during the off time of the power device. That energy dissipates on the resistor R1 in parallel with the capacitor C4. This kind of clamping circuit is called a passive clamping circuit, because it simply dumps the energy from the leakage inductance to the resistor. Passive clamping circuit is very simple but introduces extra power loss on the resistor, and thus reduces the overall power efficiency of the flyback converter.

The above phenomena also exist in push-pull converters and any other DC/DC converters that incorporate a transformer and whose switching device's active node (drain for MOSFETs and collector for IGBTs) has no direct energy releasing path to the power supply.

The present invention is a circuit topology that uses an active clamping circuit to combat the loss due to parasitic energy in the leakage inductance of the transformer at minimum cost and improved efficiency.

### BRIEF DESCRIPTION

An active clamping circuit is proposed in this invention to capture the energy originated from the leakage inductance and convert it back to either the load side or the power supply side of the main DC/DC converter in order to boost the overall power efficiency.

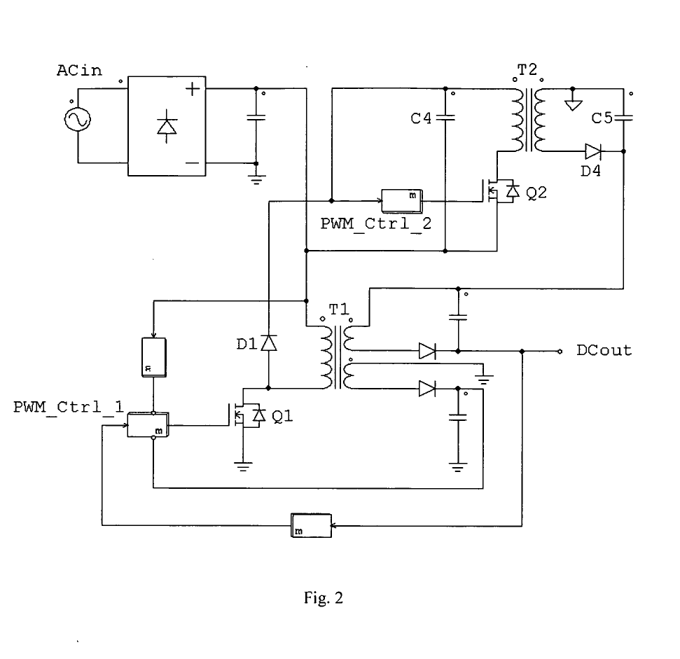

The proposed active clamping circuit uses a dedicated auxiliary flyback converter (or so called an active clamping converter) as the energy transferring device. FIG. 2 is an example of the output of the auxiliary energy recirculation flyback converter being serially connected to the output of the main DC/DC flyback converter (PWM_Ctrl_1 and PWM_Ctrl_2 are the two PWM gate control signals, respectively, one for the main DC/DC converter power switching device and the other for the auxiliary energy recirculation converter power switching device). The energy collected by the clamping circuit (D1 and D4 in FIG. 2) is redirected to the actual load by this energy transferring converter and will not be dissipated on a resistor as in the passive clamping circuit. The overall efficiency of the main DC/DC flyback converter has thus been significantly improved with this re-circulated energy. It also reduces the thermal design requirements of the main DC/DC converter.

Please note that the main DC/DC converter could be a flyback converter or a push-pull converter or any other DC/DC converter that incorporates a transformer and whose switching device's active node (drain for MOSFETs and collector for IGBTs) has no direct energy releasing path to the power supply.

### DISCLOSURE OF THE INVENTION

This auxiliary energy recirculation flyback/active clamping converter is different from the main DC/DC converter in the following aspects.
The power requirement for this auxiliary energy recirculation flyback DC/DC converter is much lower compared to the main DC/DC converter, in most applications, less than 10% of the power requirement for the main DC/DC converter, since a transformer's leakage inductance is typically only a few percent of the primary coil inductance.
This auxiliary energy recirculation converter does not need a startup circuit. It is trigged by the main DC/DC converter.
This auxiliary energy recirculation converter's control circuit gets its power supply either from the main DC/DC converter or from the recovered power from the main DC/DC converter.
The regulation of the auxiliary energy recirculation flyback converter is referenced to the clamping voltage instead of the load voltage as in the main DC/DC converter, eliminating the need for a complex isolated feedback control loop.
The auxiliary energy recirculation converter can be simple, small and low cost. It does not require high conversion efficiency; 80-90% is acceptable.

FIG. 2 depicts a simplified diagram of the auxiliary energy recirculation flyback (active clamping) converter. Q2 is the switching device controlled by a PWM control signal (PWM_Ctrl_2). T2 is the flyback energy conversion transformer. Q2's on time duty cycle depends on the clamping voltage across C4. A higher clamping voltage on C4 will cause a longer on time of Q2, thus will convert more energy from C4 to C5.

The leakage inductance of the auxiliary flyback transformer will generate high voltage spikes on switching device Q2. A simple passive diode/capacitor/resistor clamping circuit could be used to suppress those high voltage spikes or it could be left untreated (as in the case of FIG. 2) due to its low power nature and small impact on the function of Q2.

The output energy of the active clamping converter on C4 could be added to the energy from the main DC/DC converter either in a series configuration or in a parallel configuration. FIGS. 2-5 show all configurations, respectively.

FIG. 1—A typical passive clamping flyback converter;

FIG. 2—The output of the auxiliary energy recirculation converter is connected to the output of the main DC/DC converter in series;

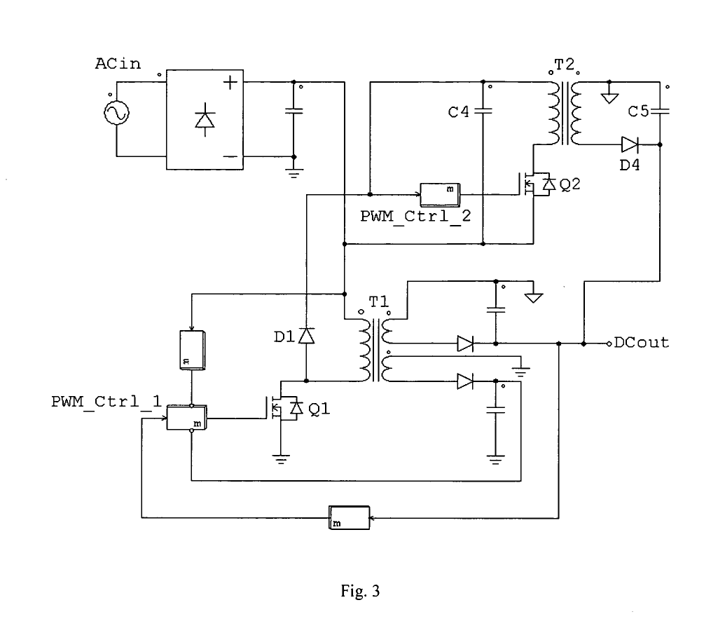

FIG. 3—The output of the auxiliary energy recirculation converter is connected to the output of the main DC/DC converter in parallel;

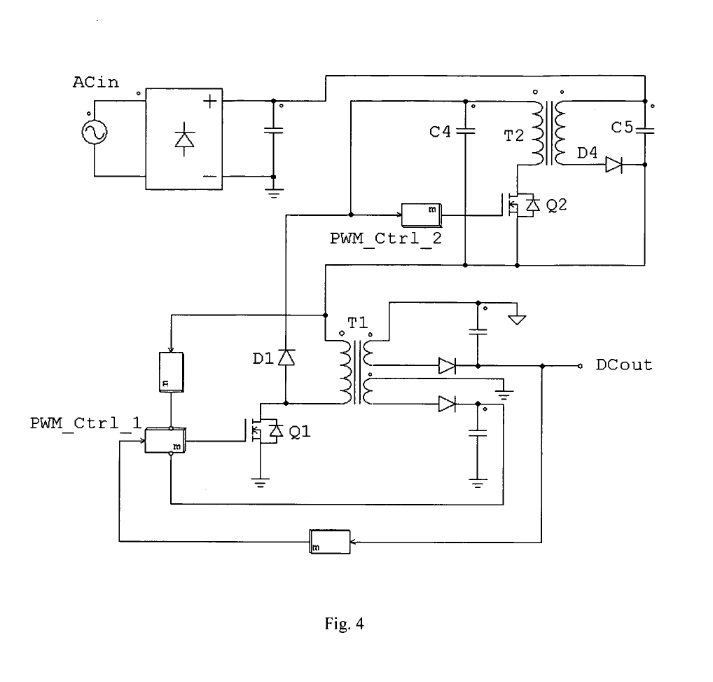

FIG. 4—The output of the auxiliary energy recirculation converter is connected to the input of the main DC/DC converter in series;

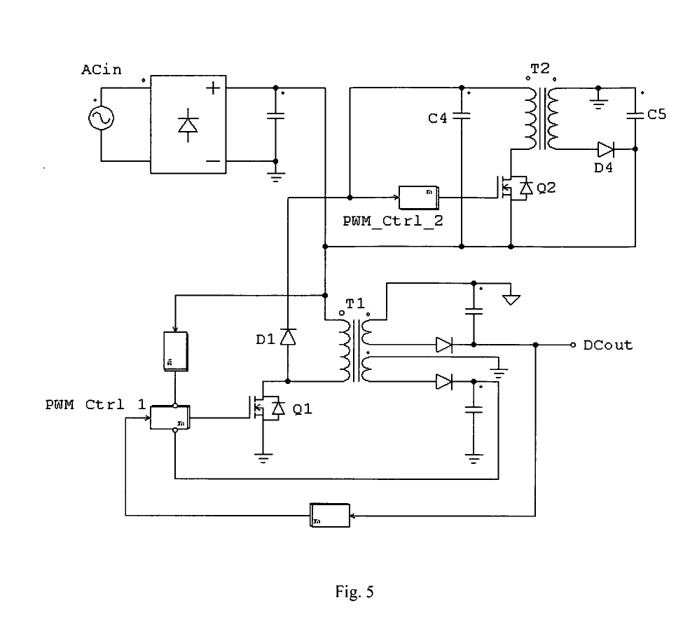

FIG. 5—The output of the auxiliary energy recirculation converter is connected to the input of the main DC/DC converter in parallel.

Note that FIGS. 1-5 all contain a diode rectifier. This rectifier allows the main DC/DC converter to directly operate with an AC voltage input as an AC/DC converter or as a switching power supply. Also note in FIGS. 1-5, dots on transformers indicate inphase pins, while dots on other components indicate Pin 1.

### BEST MODE FOR CARRYING OUT THE INVENTION

The present invention can be used in a flyback converter or a push-pull converter or any other DC/DC converter that incorporates a transformer and whose switching device's active node (drain for MOSFETs and collector for IGBTs) has no direct energy releasing path to the power supply. The present invention uses a small auxiliary flyback converter to re-circulate energy in the leakage inductance to boost the overall DC/DC converter's power efficiency at minimum cost.

A prototype switching power supply with a passive clamping circuit (FIG. 1) was built as a comparison baseline. A prototype switching power supply with an active clamping circuit (FIG. 2) was developed to demonstrate the advantages of the energy recirculation proposed in this invention.

Here are some system specifications and component parameters used in the prototype.

Main Switching Power Supply Specifications:

| | |
|---|---|
| Input Voltage | 90-265 VAC |
| Output Voltage | 24 VDC |
| Output Power | 150 W continuous |
| Switching Frequency | 30 kHz |

Passive Clamping Circuit Components (FIG. 1):

| | |
|---|---|
| D1 | 1N5739 |
| C4 | 22 nF/630 V |
| R1 | 10k/10 W |

Auxiliary Energy Recirculation/Active Clamping Flyback Converter (FIG. 2):

| Input Voltage | 150-350 VDC |
|---|---|
| Output Voltage | 5 VDC/2 A |
| Output Power | 10 W |
| Efficiency | 85% |

The experiment demonstrates that the overall AC/DC conversion efficiency is 87% with the passive clamping and 91% with the auxiliary energy recirculation flyback converter/active clamping.

The invention claimed:

1) A circuit topology to redirect the energy stored in a transformer's or an inductor's leakage inductance in a DC/DC converter to either the load side or the power supply side (energy recirculation) to improve the DC/DC converter's overall efficiency. This main DC/DC converter could be a flyback converter or a push-pull converter or any other DC/DC converter that incorporates a transformer and whose switching device's active node (drain for MOSFETs and collector for IGBTs) has no direct energy releasing path to the power supply.

2) The topology according to claim 1) where said energy recirculation in claim 1) is accomplished by a dedicated auxiliary DC/DC converter;

3) The topology according to claim 1) where the auxiliary energy recirculation converter in claim 1) is itself a flyback converter with lower power rating.

4) The topology according to claim 1) where the auxiliary energy recirculation converter in claim 1) receives its power supply either from the main DC/DC converter or from the recovered power from the main DC/DC converter;

5) The topology according to claim 1) where the auxiliary energy recirculation converter in claim 1) functions only when the clamping voltage is above a certain threshold, which may be adjusted by a resistive voltage divider or a zener diode;

6) The topology according to claim 1) where the switching device's on time duty cycle in the auxiliary energy recirculation converter in claim 1) is controlled by a desired clamping voltage and the auxiliary energy recirculation converter could be a constant input voltage or quasi constant input voltage DC/DC converter;

7) The topology according to claim 1) where the output of the auxiliary energy recirculation converter in claim 1) is connected to the output of the main DC/DC converter in either a series configuration or a parallel configuration;

8) The topology according to claim 1) where the output of the auxiliary energy recirculation converter in claim 1) is connected to the input of the main DC/DC converter in either a series configuration or a parallel configuration;
